(19) United States
(12) Patent Application Publication
(10) Pub. No.: US 2020/0120162 A1
(43) Pub. Date: Apr. 16, 2020

(54) APPARATUS AND METHODS FOR DECLARATIVE CONTROL AND QUERY OF DEVICES CONNECTED TO A COMPUTER NETWORK

(71) Applicant: VIXTERA, INC., Danville, CA (US)

(72) Inventors: Yuriy DAVELMAN, West Bloomfield, MI (US); Greg IOFFE, Danville, CA (US); Andrii PROSOV, Kharkiv (UA)

(21) Appl. No.: 16/600,247

(22) Filed: Oct. 11, 2019

Related U.S. Application Data
(60) Provisional application No. 62/745,199, filed on Oct. 12, 2018.

(51) Int. Cl. H04L 29/08; G06F 16/245; H04L 29/06

(52) U.S. Cl. CPC H04L 67/125; H04L 69/08; G06F 16/245

(57) ABSTRACT

A method and apparatus of a management device that sends a command to a device is described. In an exemplary embodiment, the management device receives an operation for a managed device, wherein the operation includes an operation request, operation command, and operation response. The management device determines a device type and protocol and identifies an operation request for the device protocol. The management device further populates a device command for the device from at least one of the operation command and operation request. In addition, the management device sends the device command to the managed device and receives a device response from the managed device. Furthermore, the management device populates an operation response from the device response. The management device additionally sends the operation response to a software system that stores the operation response.

This application claims the benefit of priority of U.S. Provisional Patent Application No. 62/745,199 filed on Oct. 12, 2018, and incorporates herein by reference this provisional patent application.

### FIELD OF INVENTION

This invention relates generally to device management and specifically to device management communication in a system that consists of devices connected to a computer network.

### BACKGROUND OF THE INVENTION

In modem devices ecosystem, majority of devices are “intelligent”, e.g., any type of equipment, instrument or machine have the capability to interact with software systems. Software systems may control the devices, for example, performing firmware downloads and updates, reboots, and factory resets, as well as receiving devices' operational data such as voltage, temperature, etc., either getting it on-demand or as a result of devices' generated alerts.

To date, there is no industry standard that defines a common set of operations that can be executed by intelligent devices. Each device manufacturer develops its own protocol for device control and data query. The device protocol defines a set of supported operations, for example: shutdown, get voltage etc. In order to enable a software system to interact with devices, a specialized software and protocol operations has to be developed for each specific model of the device.

### SUMMARY OF THE DESCRIPTION

A method and apparatus of a management device that sends a command to a device is described. In an exemplary embodiment, the management device receives an operation for a managed device, wherein the operation includes an operation request, operation command, and operation response. The management device determines a device type and protocol and identifies an operation request for the device protocol. The management device further populates a device command for the device from at least one of the operation command and operation request. In addition, the management device sends the device command to the managed device and receives a device response from the managed device. Furthermore, the management device populates an operation response from the device response. The management device additionally sends the operation response to a software system that stores the operation response.

Other methods and apparatuses are also described.

### BRIEF DESCRIPTION OF THE DRAWINGS

The present invention is illustrated by way of example and not limitation in the Figures of the accompanying drawings in which like references indicate similar elements.

FIG. 1 is a block diagram of one embodiment of an apparatus and devices coupled over a network.

FIG. 2 is a block diagram of one embodiment of apparatus architecture to perform root cause analysis on a system of multiple devices.

FIG. 3 is an illustration of a structure of a device definition.

FIG. 4 is an illustration of one embodiment of a protocol structure.

FIG. 5 is a flow diagram of one embodiment of a process that sends and receives a command with a device.

FIG. 6 illustrates one example of a typical computer system, which may be used in conjunction with the embodiments described herein.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

An apparatus and method of establishing interaction with devices connected to a computer network or directly to the apparatus is described, where the apparatus establishes a communication connection between the software system and managed devices. The method defines the interaction rules between the software systems and the managed devices. The method is based on a set of logic that allows a device to interact with the software system using a declarative device protocol.

In a modern devices ecosystem, a majority of devices are “intelligent”, e.g., any type of equipment, instrument or machine can have the capability to interact with software systems. Software systems may control the devices, for example, by performing firmware downloads and updates, reboots, and factory resets, as well as receiving devices' operational data such as voltage, temperature, etc., either getting it on-demand or as a result of devices' generated alerts.

To date, there is not an industry standard that defines a common set of operations that can be executed by intelligent devices. For example and in one embodiment, each device manufacturer develops its own protocol for device control and data query. The device protocol defines a set of supported operations, for example: get voltage, get current, get temperature, update configuration, get property value, get values for some or all sensors, getting values from one or more components of a device (e.g., get voltage from phase 1, or another types of component of a device), corresponding set operations (e. g., set voltage, set current, etc.), shutdown, update configuration, and/or other types of operations. In another embodiment, the set of supported operations can be different for different device types. For example and in one embodiment, an operation for a power distribution unit (PDU) could be get voltage on phase 1, whereas for an air conditioner, and operation can be “get temperature.” In one embodiment, in order to enable a software system to interact with devices, a specialized software and protocol operations has to be developed for each specific model of the device.

In one embodiment, an apparatus and a method for software system/device interaction that assumes that device protocols can be defined as a set of atomic units (e.g., operations), where any operation has the identical structure and is being device agnostic.

Generally speaking, an operational structure includes a set of optional input/output parameters and commands. For example and in one embodiment, an operation to get a voltage reading from a PDU will contain an input parameter “phase”—that is a phase to read the voltage from, a command “get voltage” and an output parameter “voltage” containing the voltage value.

Each operation can be defined declaratively using a common declarative language (XML, JSON) and can be interpreted by a driver common to the operations of one or more protocols, thus avoiding a laborious process of writing specialized software for the different operations and/or protocols.

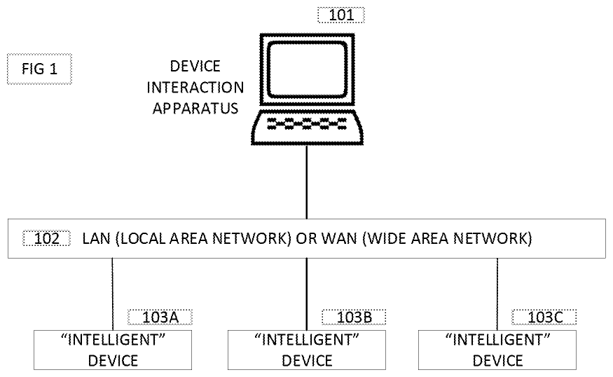

FIG. 1 is a block diagram of one embodiment of an apparatus 101 and devices 103A-C coupled over a network 102. In FIG. 1, the device interaction apparatus 101 is coupled to intelligent devices 103A-C that generates live alerts and signal data either via local or wide area network 102. Thus, the device interaction apparatus 101 can local on the same network as the intelligent devices 103A-C or can be on a network different from the network that includes the intelligent devices 103A-C (e.g., the device interaction apparatus 101 can be a physical or virtual device in a cloud service provider). In one embodiment, an intelligent device 103A-C is one that includes an agent that can receive commands from the device interaction apparatus 101 and send responses to those commands back to the device interaction apparatus 101. In one embodiment, each of the intelligent devices 103A-C includes inputs to that device 103A-C and outputs from the device 103A-C that can be measured using a sensor for that input or output. In one embodiment, the device 103A-C can be a water pump, air conditioner, power generator, power supply, server or other type of computing device, networking device (e.g., switch, router, bridge, hub, and/or another type of device that can communicate data), uninterruptible power supply, power distribution unit, and/or any other type of device. In a further embodiment, each of the inputs and/or output can have one or more thresholds that represent an acceptable operating range or environment. For example and in one embodiment, an input to a device 103A-C can have a minimum threshold, a maximum threshold, and/or a combination thereof. Similarly, another device can have an output that has a minimum threshold, a maximum threshold, and/or a combination thereof. While in one embodiment, three devices 103A-C are illustrated, in alternate embodiment, there can be more and less devices.

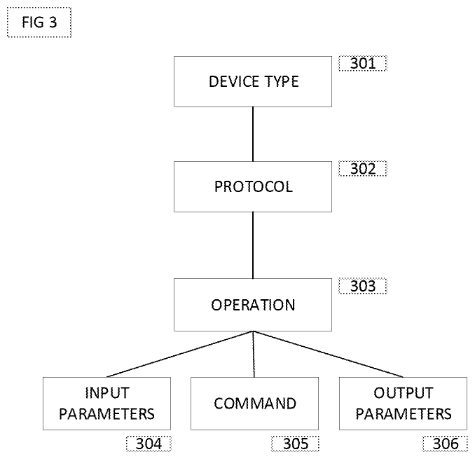

In one embodiment, the proper operating environment of the intelligent devices 103A-C can be determined using a set of rules for each topology of the intelligent device 103A-C. In this embodiment, a device topology is characterized in a form of inputs and outputs, where the inputs define the signals coming into device and the outputs define the outgoing signals (for example in a water pump electric current and voltage are inputs and pressure is an output (as shown in FIG. 3B below)). Inputs and outputs have associated sensors to enable data collection. Each device may have an internal topology that can be also expressed in the terms of inputs and outputs. From the root cause analyzer point of view, any part of a device can be represented by topology and sensors that are associated with this part's inputs and outputs. In addition, each topology has a set of associated rules. A rule is a condition that defines the input values that may be the cause for the incorrect output value. For example, output pressure is less than 20 pa, because input voltage is less than 110V or electric current is less than 1.5 A.

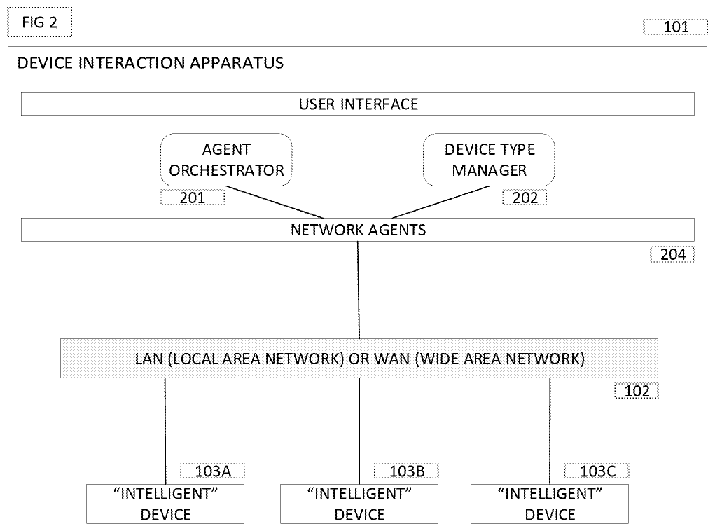

FIG. 2 is a block diagram of one embodiment of apparatus architecture to perform root cause analysis on a system of multiple devices. In FIG. 2, the device interaction apparatus (101) architecture is illustrated as a set of interconnected modules. In one embodiment, the device interaction apparatus 101 is coupled to the intelligent devices 103A-C. While in one embodiment, there are three intelligent devices 103A-C, in alternate embodiments, there can be more or less number of intelligent devices. In one embodiment, the apparatus includes the following modules:
agent orchestrator (201)—allows for management of various entities and data visualization
device type manager (202)—automatically discovers devices, determines device type and stores device into device's catalog
Network agents (204)—modules responsible for device/apparatus network communications and command and response translation.

In one embodiment, a device type is a definition of a group of devices with a common set of characteristics (specifications) and identical internal topology (for example, water pumps, air conditioners, power supplies, and/or another type of device). For example and in one embodiment, a device type has the same or similar topology. For example and in one embodiment, a water pump has a “pressure” output, but can have a single phase or multiple phases of power input. Generally speaking, a device type is a representation of identical output and identical set of piles. Each device type can have an internal topology. In one embodiment, an internal topology is a representation of the internal structure of a single device as a set of black boxes. Each black box has a set of inputs and a set of outputs. Each black box represents a subcomponent and the black boxes are interconnected through inputs and outputs.

The device topology is characterized in a form of inputs and outputs, where inputs define the signals coming into device and outputs define the outgoing signals (for example, in a water pump electric current and voltage are inputs and pressure is an output). Inputs and outputs have the associated sensors to enable data collection. In addition, each device may have an internal topology that can be also expressed in the terms of inputs and outputs. From the root cause analyzer point of view, any part of a device can be represented by a device's internal topology and sensors that are associated with this part's inputs and outputs.

FIG. 3 is an illustration of a structure of a device definition 300. In FIG. 3, the device definition 300 includes a device type 301, which includes one or more protocols 302. In one embodiment, the device type 301 is a definition of a group of devices with a common set of characteristics (e.g., a specification) and identical internal topology (for example, water pumps, air conditioners, power supplies, and/or another type of device) and a protocol 302 is system of rules and/or formats that allow one device to communicate with a device of device type 301. In one embodiment, the protocol 302 includes one or more operations 303 and/or macros that are defined for a specific device type 301. In one embodiment, an operation is a combination of an input (e.g., a request), an output (e.g., a response), a command, parameters, and/or a combination therein. In one embodiment, the input (or request) is used to create a request for the operation. The request can include parameters that are used for the command In one embodiment, the request can be sent through an application programming interface, where the request contains the parameters used to support the request. For example and in one embodiment, a request for “.../viedge/{device ip address}” request can include request data such as:

{

“device_type”:“PDU”,
//sensor “voltage sensor” is defined in the protocol
“sensor”:“voltage sensor”
//operation “get voltage” is defined in the protocol
“operation”:“get voltage”,
“parameters”[

{

//parameter “phase” is defined in the protocol
“phase”:“1”

}

]

}

In one embodiment, the voltage sensor, operation get voltage, and phase are defined in the protocol.
In one embodiment, the command is an instruction for the device to perform an action, such as an action to return a value of an input or output signal, setting of a value, and/or another type of action. In one embodiment, the command is a code, string, and/or other type of instruction that is transmitted to the target device. In this embodiment, the command can be a proprietary code that is used to perform the action. The proprietary code can be an integer and/or another type of format. For example and in one embodiment, a command=53 can be a command to get the voltage for a given phase of a target device. In one embodiment, each different device type can have a different command set.

In one embodiment, the response is a characterization of the response from the device. In this embodiment, the response can describe the type of output the command may have. This type of response can be described using output parameters for the response. For example and in one embodiment, for the command of get voltage, the output parameters would be the voltage. In one embodiment, the operation in the request uses the operation name parameters defined in the protocol. The response can contain response data such as:

{

“device_type”:“PDU”,
“sensor”:“voltage sensor”
“operation”:“get voltage”,
“values”[

{

//value for phase 1
“voltage”:“110.1”

}

]

}

As another example and embodiment, an operation to get a voltage reading from a PDU will contain an input parameter “phase”—that is a phase to read the voltage from, a command “get voltage” and an output parameter “voltage” containing the voltage value.

In one embodiment, each operation can be defined declaratively using a common declarative language (Extended Markup Language (XML), Yet Another Markup Language (YAML), JavaScript Object Notation (JSON), and/or some other type of declarative language) and can be interpreted by a driver common to all operations of all protocols, thus avoiding a laborious process of writing a specialized software.

In one embodiment, an operation 303 includes input parameters 403 (or, just “parameters”), commands 305, output parameters 306, and/or a combination therein. In this embodiment, an operation 303 can be defined as follows:

operation

operation name
command
request

parameters

parameter

parameter name
units of measure
value
formula

parameter

parameter name
units of measure
value
formula

...

response

parameter

parameter name
units of measure
value
formula

parameter

parameter name
units of measure
value
formula

. . .

### Where:

Operation name—a unique operation name for a specific device type
Command—a command code to be sent to the device
Request—a set or parameters to be sent to the device
Response—a set of parameters to be received from the device as a result of operation
Parameter name—a unique name for a specific request
Value—a parameter value that either set by the system or received as a response from the device
Formula—an expression to be applied to the value before request is send or after response is received

### Operation Example:

operation

operation name: get voltage
command: 0x57
request

parameters

parameter

parameter name: phase
units of measure: none
value: 1
formula: none

response

parameter
parameter name: voltage
units of measure: volt
value: 1100
formula: value/10

For example and in one embodiment, this operation is a query of power generator's voltage value from phase 1.

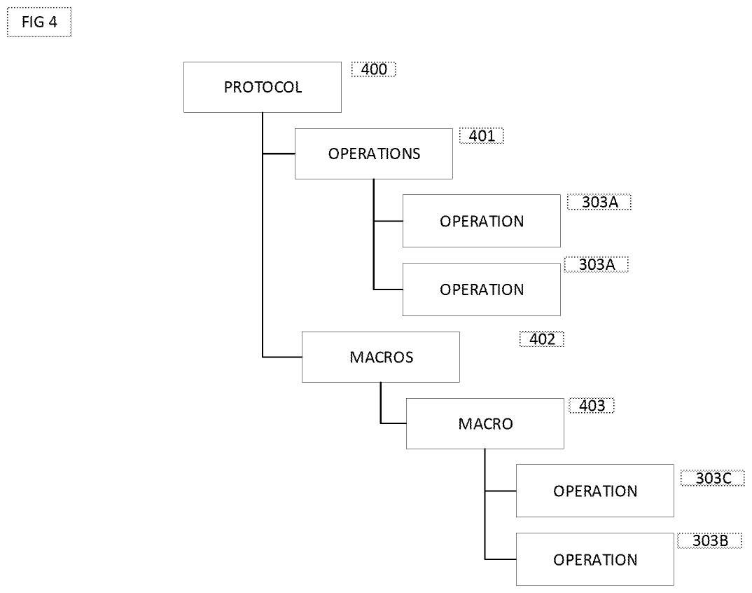

In one embodiment, a protocol can include one or more operations and one or more macros. In this embodiment, a macro is a sequence of multiple operations. In many cases, to obtain a desired result, there is a need to combine several operations into a sequence. For example, in order to obtain a voltage value from a specific electric socket of a PDU, it may be first required to select the electric socket. FIG. 4 is an illustration of one embodiment of a protocol 400 structure. In one embodiment, a protocol 400 is a language definition that is used to define the various operations and/or macros for a particular device type. In FIG. 4, a protocol 400 includes one or more operations 401 and/or macros 402. In one embodiment, the operations 401 can include multiple operations 303A-B that are part of the protocol 400. In another embodiment, macros 402 include one or more macros 403. Macro 403 is a sequence of multiple operations 303C-D in a particular sequence. In one embodiment, a macro 403 can be defined as:

macro

macro name
operations

operation name

parameter

parameter name
parameter value
. . .

. . .

### Where:

Macro name is a unique operation name for a specific device type
Operations are the operation sequences
Operation name is an operation in the sequence
Parameter is an optional operation request parameter

### Macro Example:

macro

macro name: get socket voltage

operations
operation name: set socket

parameter

parameter name: socket number
parameter value: 1

operation name: set voltage

The above example defines a macro for a query of PDU voltage value for socket #1.

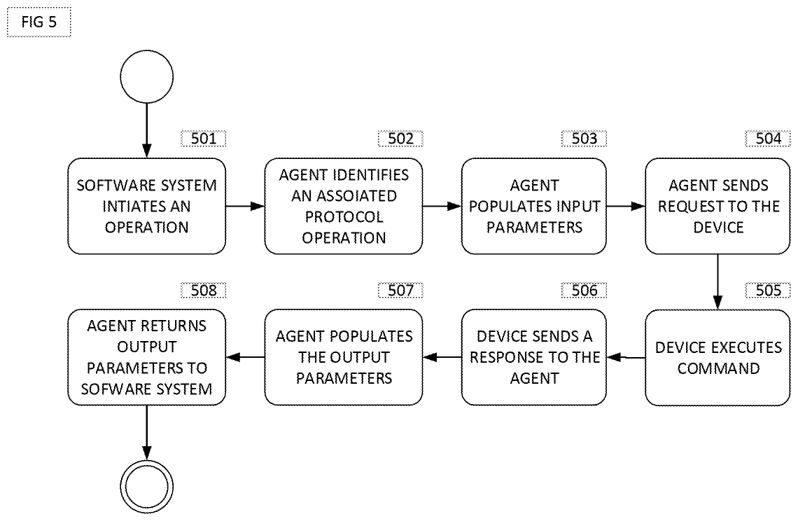

In one embodiment, the apparatus interacts with a device via one of the agents as follows:
A software system requests an operation execution
Agent recognizes the requested device type and associated protocol
Agent identifies operation of the device protocol associated with an operation request of the software system
Agent populates request parameters and commands based on the operation definition of the protocol
Agent sends request to a device
Device executes the protocol operation and sends a response to the agent
Agent populates the output parameters
Agent sends a response to the software system
   FIG. 5 is a flow diagram of one embodiment of a process 500 that sends and receives a command with a device. In one embodiment, a network agent executes process 500 to send and receive a command with a device, such as the network agent 204 as described in FIG. 2 above. In FIG. 5, process 500 begins by the software system initiating an operation at block 501. At block 502, process 500 identifies an associated protocol operation. Process 500 populates input parameters at block 503. In one embodiment, process 500 populates the input parameters using an agent and parameters that are specific for a target device. In one embodiment, by populating the request, process 500 creates a command that is sent to the target device in the native language or format of the target device. For example and in one embodiment, for a get voltage operation, the command could be “53” along with any associated parameters. At block 503, process 500 sends the command to the device. At block 505, the device executes the command. The device sends a response to the command to the agent at block 506. In one embodiment, the response is in the language or format of the target device. At block 507, process 500 populates the output parameters using the response from the device. In one embodiment, process 500 populates the output parameters in an operation response, as described above. Process 500 returns the output parameters to the software system at block 508.

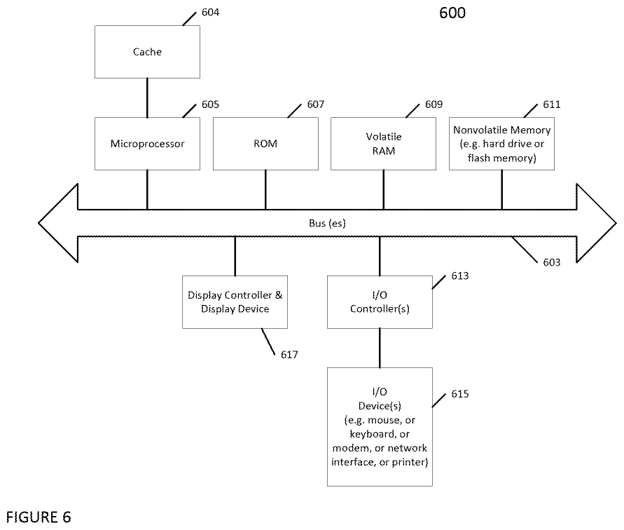

FIG. 6 shows one example of a data processing system 600, which may be used with one embodiment of the present invention. For example, the system 600 may be implemented including an apparatus 101 as shown in FIG. 1. Note that while FIG. 6 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 6, the computer system 600, which is a form of a data processing system, includes a bus 603 which is coupled to a microprocessor(s) 605 and a ROM (Read Only Memory) 607 and volatile RAM 609 and a non-volatile memory 611. The microprocessor 605 may retrieve the instructions from the memories 607, 609, 611 and execute the instructions to perform operations described above. The bus 603 interconnects these various components together and also interconnects these components 605, 607, 609, and 611 to a display controller and display device 617 and to peripheral devices such as input/output (I/O) devices which may be mice, keyboards, modems, network interfaces, printers and other devices which are well known in the art. In one embodiment, the system 600 includes a plurality of network interfaces of the same or different type (e.g., Ethernet copper interface, Ethernet fiber interfaces, wireless, and/or other types of network interfaces). In this embodiment, the system 600 can include a forwarding engine to forward network date received on one interface out another interface.

Typically, the input/output devices 615 are coupled to the system through input/output controllers 613. The volatile RAM (Random Access Memory) 609 is typically implemented as dynamic RAM (DRAM), which requires power continually in order to refresh or maintain the data in the memory.

The mass storage 611 is typically a magnetic hard drive or a magnetic optical drive or an optical drive or a DVD ROM/RAM or a flash memory or other types of memory systems, which maintains data (e.g. large amounts of data) even after power is removed from the system. Typically, the mass storage 611 will also be a random-access memory although this is not required. While FIG. 6 shows that the mass storage 611 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 603 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “process virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “performing,” “generating,” “determining,” “marking,” “applying,” “adding,” “training,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium claim having executable instructions to cause one or more processing units perform a method to send a command to a device, the method comprising:
receiving an operation for a device, wherein the operation includes an operation request, operation command, and operation response;
determining a device type and protocol;
identify an operation request for the protocol;
populating a device command for the device from at least one of the operation command and operation request;
sending the device command to the device;
receiving a device response from the device;
populating an operation response from the device response; and
sending the operation response to a software system that stores the operation response.

2. The machine-readable medium of claim 1, wherein the device type is a definition of a group of device with a common set of characteristics.

3. The machine-readable medium of claim 1, wherein the protocol for a device includes at least one of a command and a macro.

4. The machine-readable medium of claim 3, wherein the device command is an instruction for the device to perform an instruction.

5. The machine-readable medium of claim 3, wherein the device command is a proprietary string that is specific to the device.

6. The machine-readable medium of claim 3, wherein a macro is a sequence of multiple instructions.

7. The machine-readable medium of claim 1, wherein the device response is the output of device in response to the device command

8. The machine-readable medium of claim 1, wherein the device has at least one input and one output.

9. The machine-readable medium of claim 1, wherein the device is one of a water pump, power generator, air conditioner, and power supply.

10. A method to send a command to a device, the method comprising:
receiving an operation for a device, wherein the operation includes an operation request, operation command, and operation response;
determining a device type and protocol;
identify an operation request for the device protocol;
populating a device command for the device from at least one of the operation command and operation request;
sending the device command to the device;
receiving a device response from the device;
populating an operation response from the device response; and
sending the operation response to a software system that stores the operation response.

11. The method of claim 10, wherein the device type is a definition of a group of device with a common set of characteristics.

12. The method of claim 10, wherein the protocol for a device includes at least one of a command and a macro.

13. The method of claim 12, wherein the device command is an instruction for the device to perform an instruction.

14. The method of claim 12, wherein the device command is a proprietary string that is specific to the device.

15. The method of claim 12, wherein a macro is a sequence of multiple instructions.

16. The method of claim 10, wherein the device response is the output of device in response to the device command.

17. The method of claim 10, wherein the device has at least one input and one output.

18. The method of claim 10, wherein the device is one of a water pump, power generator, air conditioner, and power supply.
